(19) United States
(12) Patent Application Publication
(10) Pub. No.: US 2015/0317672 A1
(43) Pub. Date: Nov. 5, 2015

(54) System and Method for Event Management with Explicit Content Delivery Through Dynamic Network Authentication

(71) Applicants: Manuel A. Espinoza, Anaheim, CA (US); Tsongshyan Wang, Laguna Hills, CA (US)

(72) Inventors: Manuel A. Espinoza, Anaheim, CA (US); Tsongshyan Wang, Laguna Hills, CA (US)

(21) Appl. No.: 14/268,172

(22) Filed: May 2, 2014

(51) Int. Cl. G06Q 30/02

(52) U.S. Cl. CPC G06Q 30/0252; G06Q 30/0277

(57) ABSTRACT

A system and method for exchanging data in a controlled network provides each participant in an event with a data storage medium that can be accessed throughout the event in order to readily share data among the participants. Scan data for the data storage medium of each of the participants is recorded and relayed to an event host in real time. Additionally, the scan data is graphically organized and distributed to the participants following the event to facilitate continual contact between the participants. A user account accessed on a user controlled device is authenticated through the controlled network, such that event based advertisements determined by the event host can be delivered to the user controlled device. Authentication of the user account and distribution of each of the event based advertisements is facilitated by inserting either an authentication source code or advertisement source code into a webpage source code.

### FIELD OF THE INVENTION

The present invention relates generally to event management. More specifically, the present invention is a system and method for exchanging data in a controlled network. Furthermore, the present invention provides a means for registering attendees, authenticating user controlled devices of the attendees, delivering targeted content to the user controlled devices, and facilitating the exchange of data among attendees.

### BACKGROUND OF THE INVENTION

One of the most effective means of spreading information within large scale communities, such as those found in medicine, academia, or corporate business, is through educational conferences. Conferences are usually characterized by the gathering of a large amount of people who share a common interest in order to confer, interact, sell, buy, and expand their professional network. While academic and business conferences are the most publically known conference events, such events occur for a multitude of other topics and subjects.

Contrary to the current trend of the assimilation of technology into everyday life, conference event management mires in the past. Name tags, hand applications, and pamphlet schedules are still the norm in this technology based world. These means of management are slow, inefficient, and to an extent ineffective. Additionally, this can act to discourage guests from interacting or following up with exhibitors due to the shear amount of handouts and other paperwork that is typically handed out. A guest can quickly amass a large amount of paperwork concerning the exhibitors, and at a certain point this can detract the guest from pursuing further contacts in an effort to limit the amount of paperwork received. Furthermore, once a guest has left the event, it can be difficult to search through pamphlets and other handouts, and many can become lost or are not needed.

In respect to exhibitors, it is often difficult to collect the appropriate information from the guests in order to follow up and provide future information. It is most common for each exhibitor to collect their own set of data in relation to the guest. This is time consuming and inefficient for both the exhibitor and the guest, as each guest must be registered individually with each exhibitor, thus limiting the number of interactions between guest and exhibitor. If a registration line is too long, then it may detract a guest from visiting that particular exhibitor. Additionally, in many instances, guest information is collected by exhibitors in paper form. This data must then be transferred into a digital format following the event, which is not only timing consuming for the exhibitor but can lead to the incorrect transfer of information as the data is transcribed from medium to the other.

At large conferences and other events, it is common to provide a wireless network for guests to utilize throughout the duration of the event. As such, network security is becoming ever more important in order to protect users and their personal information when it is distributed in such a public nature. To ensure user protection several methods have been employed to authenticate a user and in turn provide authorization to a network or account. Often times it is necessary for user data to be manipulated such as changing the user's IP address or changing the URL of the web page for a request that is being made. These methods of authentication work now, however, internet protocol will be switching from IPv4 to Ipv6 in the coming years. This change in protocol may not allow for user data to be manipulated in the same manner that it is currently done today.

Another network problem that exists is in regards to the distribution of advertisement content. Currently advertisements are distributed on access networks at the expense of the internet operator and the internet clients. Although they are distributed at their expense, the internet operator and clients have no control over the type of advertisements that are distributed. Advertisement content is unfiltered and the same advertisements are distributed across several networks at once for the same webpages. This provides instances of inappropriate content being distributed to certain viewers and a lack of localized advertisement respectively. In a controlled network, such as those found at a large event, it may be beneficial and desired to provide event specific advertisements, wherein the event host can determine the content that is delivered to guests.

Therefore it is an object of the present invention to provide a system and method for event management to facilitate the exchange of data among guests and exhibitors in a controlled network, wherein explicit content is delivered through the dynamic authentication of user accounts. The present invention facilitates a higher degree of user interactions during large events by providing each registered participant with a data storage medium such as a quick response (QR) code. In this way, information can be readily exchanged between participants in a matter of seconds, thus allowing for more one on one interactions throughout the duration of the event. As the QR code of each participant is scanned, scan data is stored, organized, and then distributed to the participants following the close of the event, thus allowing the participants to readily follow up with contacts they engaged during the event. In addition, the system supplies event based advertisements to keep the attendee engaged and enveloped in the event environment and atmosphere. The event based advertisements that are distributed to the participants are managed by an event host through an advertisement index file. Furthermore, the present invention allows the event host to monitor and analyze various data obtained during the event in real time and respond accordingly.

Additionally, the present invention provides a method of authentication that can be used on Internet Protocol (IP) v4 and IPv6 systems. The method of user authentication does not require any user data to be manipulated or changed. The destination IP address remains the same as well as the uniform resource locator (URL) of the website. Rather than manipulating user data, a HyperText Markup Language (HTML) insert is used to provide a means of authentication on a network. Furthermore, each of the event based advertisements is distributed across the controlled network using the same HTML methodology.

### BRIEF DESCRIPTION OF THE DRAWINGS

FIG. 1 is a flowchart of the method for exchanging data in a controlled network;

FIG. 2 is a flowchart thereof, expanding upon the creation of the data storage medium for each of the user accounts.

FIG. 3 is diagram of a badge including the data storage medium for a specific account.

FIG. 4 is a flowchart expanding on the steps of authenticating the user accounts;

FIG. 5 is a flowchart thereof, detailing the integration of an authentication pop-up into a webpage;

FIG. 6 is a flowchart thereof, detailing steps following successful authentication of the specific account.

FIG. 7 is a diagram detailing the communication paths between devices for authenticating the user accounts;

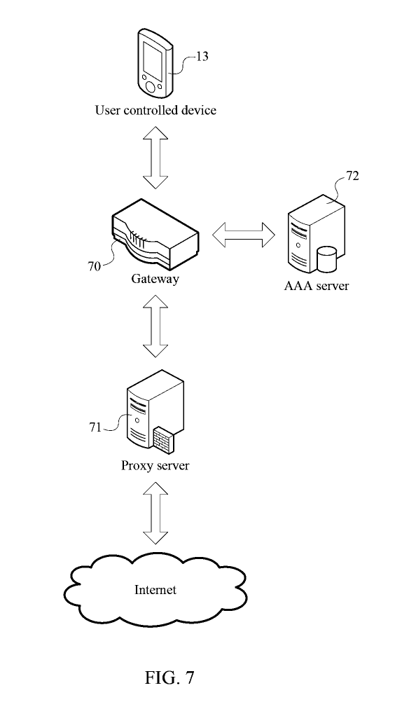

FIG. 8 is a diagram thereof, detailing the specific order in which information is transferred in order to authenticate the user accounts.

FIG. 9 is a diagram depicting the authentication pop-up displayed over a webpage;

FIG. 10 is a diagram thereof, showing the authentication pop-up removed after successful authentication.

FIG. 11 is a an example of authentication source code that can be used for the authentication pop-up.

FIG. 12 is a flowchart expanding on the steps of delivering event based advertisements to the user accounts;

FIG. 13 is a flowchart thereof, detailing selection of a specific advertisement using advertisement parameters defined by an event host;

FIG. 14 is a flowchart thereof, detailing selection of the specific advertisement according to a user class of the specific account;

FIG. 15 is a flowchart thereof, detailing the integration of the specific advertisement into the webpage.

FIG. 16 is a diagram detailing the communication paths between devices for integrating the specific advertisement into the webpage;

FIG. 17 is a diagram thereof, detailing the specific order in which information is transferred in order to integrate the specific advertisement into the webpage.

FIG. 18 is a diagram depicting the webpage having original advertisements displayed;

FIG. 19 is a diagram thereof, depicting the event based advertisements replacing the original advertisements.

FIG. 20 is a diagram of a specific advertisement displayed on a user controlled device.

FIG. 21 is an example advertisement source code that can be used for the event based advertisements.

FIG. 22 is a diagram depicting selected advertisement parameters in an advertisement index file.

FIG. 23 is a flowchart detailing the collection of scan data for other accounts by a specific account.

FIG. 24 is a flowchart detailing the collection of scan data for a specific account by other accounts.

FIG. 25 is diagram depicting the data storage medium of a specific account being scanned by a user controlled device;

FIG. 26 is a diagram thereof, depicting the option to add additional data for a specific account when the data storage medium is scanned.

FIG. 27 is a diagram depicting an alternative method of gathering registration data by manually entering the data storage medium into the user controlled device.

FIG. 28 is a diagram depicting the registration data for other accounts in a graphical display for a specific account.

### DETAIL DESCRIPTIONS OF THE INVENTION

All illustrations of the drawings are for the purpose of describing selected versions of the present invention and are not intended to limit the scope of the present invention.

The present invention is a system and method for exchanging data in a controlled network, wherein attendees of an event are registered and authenticated in order to deliver targeted content over the controlled network. The present invention facilitates and manages interaction between the attendees at an event and acts to keep the attendees engaged in the event by delivering targeted content in relation to the event. Example implementations of the present invention include, but are not limited to, sporting events, career fairs, and conferences, such as academic conferences, business conferences, news based conferences, peace based conferences, or trade orientated conferences. In order to provide the desired interactions among the attendees and between the attendees and an event host, a controlled network comprises at least one gateway 70, a proxy system 71, a content delivery system 73, and an authentication, authorization, and accounting (AAA) system 72.

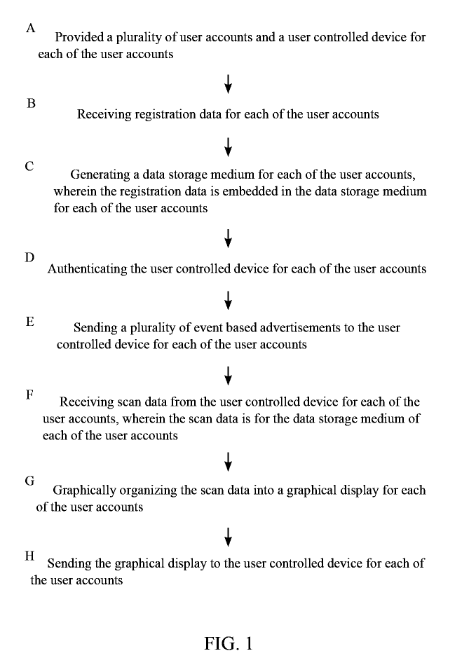

In reference to FIG. 1, the first step in the present invention is the registration of the attendees. The attendees interface with the controlled network through a plurality of user accounts 10, wherein each of the attendees is associated with a specific account 11 from the user accounts 10. A host database 74 receives registration data 20 for each of the user accounts 10, and stores said registration data 20 for use throughout the event at which the present invention is implemented. The host database 74 may be integrated into computers, servers, or other electronic storage mediums of the AAA system 72, or the host database 74 may be integrated into a standalone electronic storage system. The registration data 20 is submitted by the attendees through the plurality of user accounts 10 and may include personal information such as a full name, an email address, or a phone number of each of the attendees; business information such as a company name, a job title, or a company email address of each of the attendees; or any other type of information deemed necessary by the event host.

Additionally, each of the attendees provides a user class 21, wherein the user class 21 of each of the attendees defines the specific account 11 of each of the attendees as a particular type of attendee, such as an exhibitor, lecturer, visitor, buyer, seller, etc. An interest section may also be provided for submitting the registration data 20. The interest section allows each of the attendees to convey his or her interest in attending the event, and acts to further expand upon the user class 21 designation in order facilitate one on one interaction among the attendees throughout the event. For example, an attendee with the user class 21 designated buyer could provide more detailed information as to specific products, services, etc. that the attendee is in search of at the event. The interest section can be provided as an open field textual input or a predetermined selection of responses.

The registration data 20 may be submitted before the event begins or when the attendees arrive at the event. If the registration data 20 is supplied before the event begins, then the registration data 20 can be submitted through the user accounts 10 on a host website. As such, any electronic device, such as a smartphone, laptop, desktop, tablet, etc., having an internet connection can be used to submit the registration data 20. It is also possible for the registration data 20 to be mailed in paper form to a central registration location, wherein the registration data 20 in paper form is then converted to a digital format and associated with the user accounts 10.

If the registration data 20 is supplied when the attendees arrive at the event, then the registration data 20 is submitted through a registration unit, wherein the registration unit is an electronic device connected to the controlled network. In the preferred embodiment of the present invention, the registration unit is an electronic device having a scanner for scanning a business card or other piece of material. Software run either on the registration unit or another system within the controlled network is capable of extracting key information from the business card and formatting said information into appropriate data fields for submitting the registration data 20. The registration data 20 may also be manually entered into the registration unit.

Once the registration data 20 has been submitted, the registration data 20 for each of the attendees is verified by a registration attendant through an attendant registration unit. Similar to the registration unit, the attendant registration unit can be any electronic device connected to the controlled network.

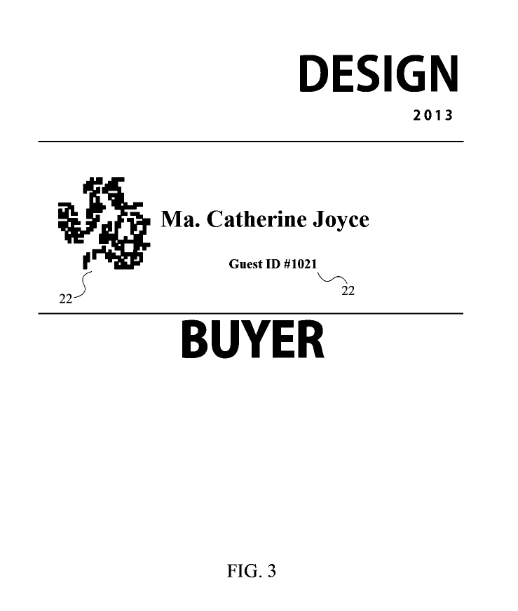

In reference to FIG. 1, once the registration data 20 for each of the user accounts 10 has been received, a data storage medium 22 is generated for each of the user accounts 10, wherein the registration data 20 is embedded in the data storage medium 22 for each of the user accounts 10. The data storage medium 22 can be any medium through which digital information can be referenced to or directly stored on. For example, the data storage medium 22 for each of the user accounts 10 can be a quick response (QR) code, barcode, identification number, or radio frequency identification tag. It is possible for the data storage medium 22 to be presented in multiple formats. In the preferred embodiment of the present invention, the data storage medium 22 is both a QR code and a personal identification number, as depicted in FIG. 3. Once generated, the data storage medium 22 is printed on or otherwise positioned onto an event badge.

If the registration data 20 is submitted prior to attending the event, then the guest badge containing the data storage medium 22 may be emailed to each of the attendees, or made available for pickup upon arriving at the event. If the registration data 20 is submitted upon arriving at the event, then the badge containing the data storage medium 22 is assembled upon arrival and submittal of the registration data 20.

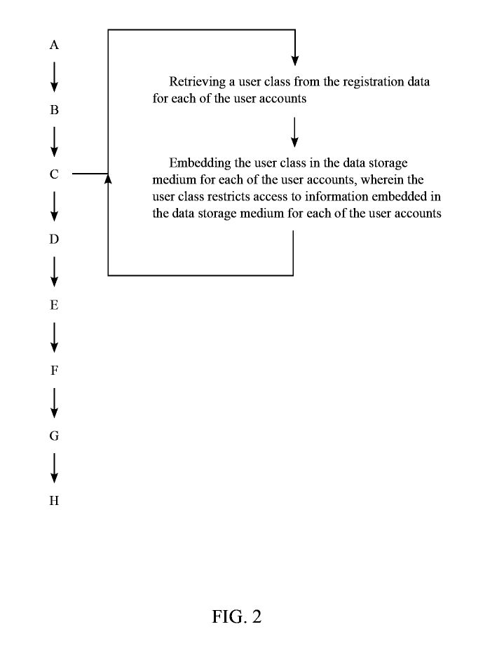

Furthermore, in reference to FIG. 2, when the data storage medium 22 is generated for each of the user accounts 10, the user class 21 is retrieved from the registration data 20 for each of the user accounts 10. Along with the rest of the registration data 20, the user class 21 is embedded into the data storage medium 22 for each of the user accounts 10. The user class 21 for each of the user accounts 10 restricts access to the rest of the registration data 20 embedded in the data storage medium 22 depending on the given situation.

Once the data storage medium 22 has been generated for each of the user accounts 10, the attendees may exchange data with each other. A user controlled device 13 for each of the user accounts 10 is used in said exchange of data, wherein the user controlled device 13 for each of the user accounts 10 is an electronic device, such as a smartphone, laptop, tablet, etc. In reference to FIG. 1, the user controlled device 13 for each of the user accounts 10 is first authenticated by the controlled network, wherein the controlled network can then send a plurality of event based advertisements 30 to the user controlled device 13 for each of the user accounts 10.

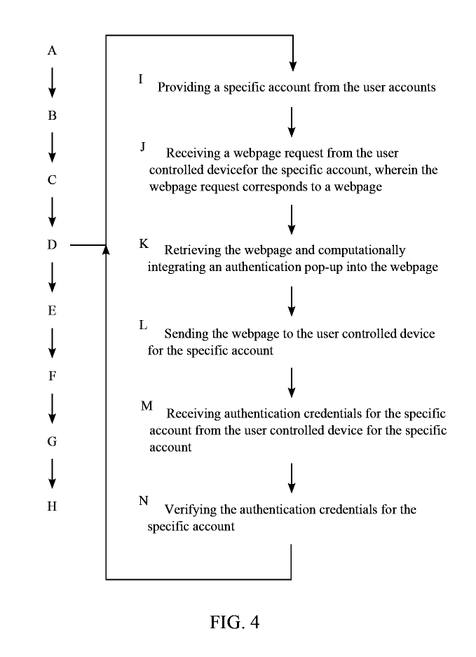

The required step of authentication is used to provide security to the controlled network. In reference to FIG. 4, when an attendee first connects to the controlled network through the user controlled device 13 and requests a webpage 41, a webpage request 40 is sent to the controlled network from the user controlled device 13, wherein the webpage request 40 corresponds to the webpage 41. The at least one gateway 70 receives the webpage request 40 from the user controlled device 13 for the specific account 11 and stores the physical address and/or the Internet Protocol (IP) address of the user controlled device 13 for the specific account 11. The at least one gateway 70 can be a modem, a router or any other electronic device capable of receiving and forwarding requests between other electronic devices.

In further reference to FIG. 4, if the specific account 11 has not been authenticated yet, then the at least one gateway 70 forwards the webpage request 40 to a proxy system 71. The proxy system 71 comprises at least one server or similar device capable of retrieving webpages. The proxy system 71 then requests the webpage 41 on behalf of the user controlled device 13 for the specific account 11. A webpage source code 42 for the webpage 41 is then retrieved by the proxy system 71.

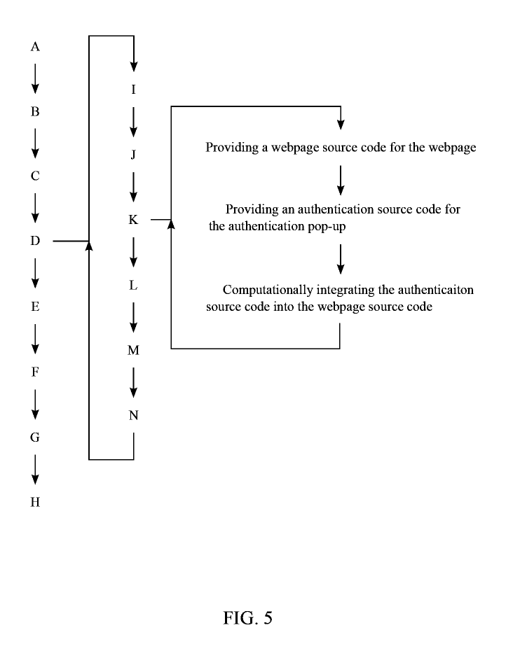

In reference to FIG. 4-5, once the webpage source code 42 for the webpage 41 has been retrieved by the proxy server, the proxy system 71 computationally integrates an authentication source code 51 into the webpage source code 42 of the webpage 41. The authentication source code 51 provides instructions for an authentication pop-up 50, wherein the authentication pop-up 50 is computationally integrated into the webpage 41. The authentication pop-up 50 includes a request for user authentication. The request for authentication could be in the form of a user identification (ID) and password or any other type of information personal to the attendee. In the preferred embodiment of the present invention the user ID and password used for the authentication process are credentials from the registration data 20 of the specific account 11 and/or the data storage medium 22 for the specific account 11, such as the personal identification number. Designated input fields are provided in the authentication pop-up 50 for the attendee to enter authentication credentials 52.

The proxy system 71 automatically detects the at least one gateway 70 and the location of the user controlled device 13 for the specific account 11, based on either the source address of the user controlled device 13 for the specific account 11 or by the signature inserted by the at least one gateway 70. Policy rules are then applied to the webpage 41 based on the source address or physical address, and the destination proxy port, and/or based on other signatures that are inserted by the gateway. A location specific authentication source code 51 may be inserted into the webpage source code 42 according to the policy rules. The location specific authentication source code 51 allows for more or less restricted network access depending on a specific location. For example, if an event has multiple exhibits or showrooms, then access through the controlled network may be limited in a specific showroom, such a main hall for giving lectures or demonstrations.

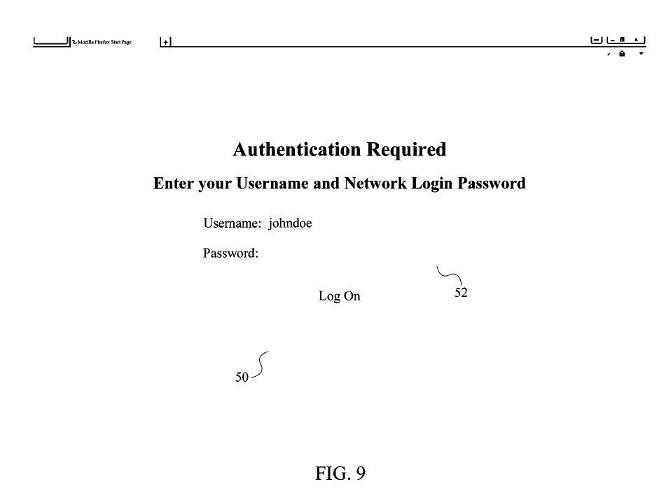

In reference to FIG. 4, once the authentication source code 51 has been inserted into the webpage source code 42, the webpage 41 is sent back to the at least one gateway 70. The at least one gateway 70 then sends the webpage 41, with the inserted authentication pop-up 50, to the user controlled device 13 for the specific account 11. First the webpage 41 is displayed to the attendee on the user controlled device 13. However, the webpage 41 is only displayed for a brief period of time, after which the authentication pop-up 50 appears, as depicted in FIG. 9. The authentication pop-up 50 contains the request for user authentication. The authentication pop-up 50 will continue to appear preventing network access until the attendee has successfully submitted the authentication credentials 52.

In reference to FIG. 4, the attendee can then enter the authentication credentials 52 into the designated input fields provided by the authentication pop-up 50. Once the attendee has entered the authentication credentials 52, the authentication credentials 52 are sent to the at least one gateway 70 from the user controlled device 13 for the specific account 11. The at least one gateway 70 receives the authentication credentials 52 from the user controlled device 13 for the specific account 11 and then forwards the authentication credentials 52 to the AAA system 72. The AAA system 72 can be a server, database or some other electronic means of verifying user submitted information. The AAA system 72 then verifies the authentication credentials 52 submitted by the attendee for the specific account 11.

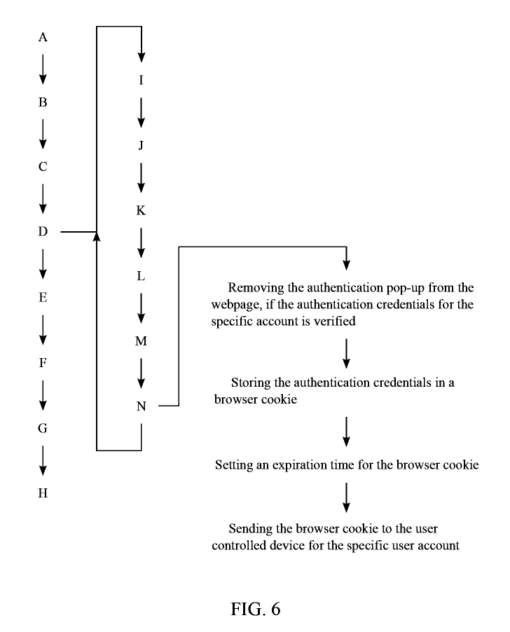

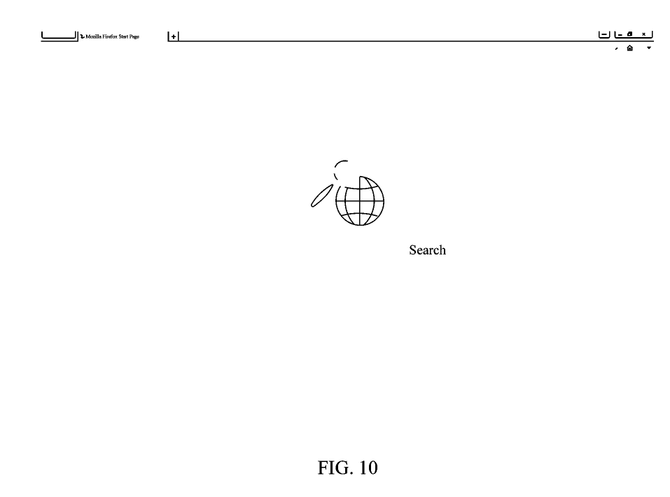

In the preferred embodiment of the present invention, the AAA system 72 compares the authentication credentials 52 against the registration data 20 for the specific account 11 stored in the host database 74. In reference to FIG. 6, if the AAA system 72 successfully verifies the authentication credentials 52, then the AAA provides authorization to the user controlled device 13 for the specific account 11 by means of the at least one gateway 70, wherein the authentication pop-up 50 is removed from the webpage 41, as depicted in FIG. 10. The AAA system 72 stores the authentication credentials 52 in a browser cookie 53 and sends the browser cookie 53 to the user controlled device 13 for the specific account 11. The user is then granted access to the controlled network and no further webpage requests are forwarded to the proxy system 71. Additionally, an expiration time 54 for the browser cookie 53 can be determined and set by the event host through the AAA system 72, such that after the expiration time 54 has passed the attendee must repeat the authentication process. If the authentication credentials 52 cannot be successfully verified, then the attendee is denied access to the controlled network and the authentication pop-up 50 will remain open preventing user access to the webpage 41.

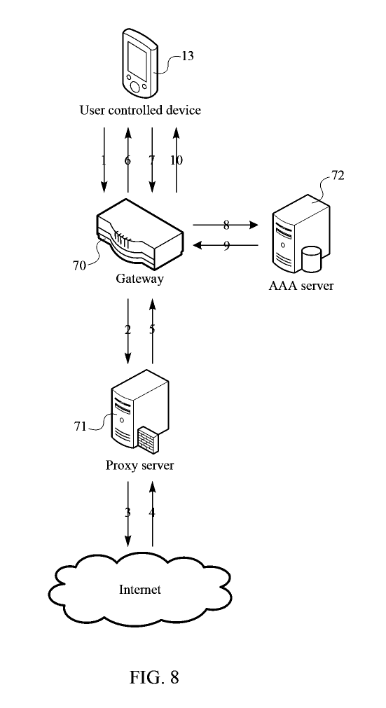

In reference to FIG. 8-9, webpage requests and authentication data are shared between a number of devices. The at least one gateway 70 allows the user controlled device 13 for the specific account 11 to communicate with the proxy system 71 and the AAA system 72. For the initial webpage request 40, only the proxy system 71 is in communication with the internet. FIG. 9 provides a numbered flow as to the order in which information is shared. The following describes the ordered connections: 1) The webpage request 40 for the webpage 41 is sent from the user controlled device 13 for the specific account 11 to the at least one gateway 70. 2) The at least one gateway 70 then forwards the webpage request 40 to the proxy system 71. 3) The proxy system 71 then requests the webpage 41 from the internet. 4) The webpage source code 42 is retrieved by the proxy system 71 from the internet. 5) The proxy system 71 then inserts the authentication source code 51 into the webpage source code 42 and sends the webpage 41 to the at least one gateway 70. 6) The at least one gateway 70 then forwards the webpage 41 with the inserted authentication source code 51 to the user controlled device 13 for the specific account 11. 7) The attendee then enters the authentication credentials 52 which is sent back to the at least one gateway 70. 8) The at least one gateway 70 then sends the authentication credentials 52 to the AAA system 72. 9) The AAA system 72 verifies the authentication credentials 52. 10) The gateway then sends the authorization information to the user controlled device 13 for the specific account 11. It is to be known that other information pathways and devices can be used that allow a requested webpage 41 to be retrieved and returned to a user with an inserted authentication pop-up 50.

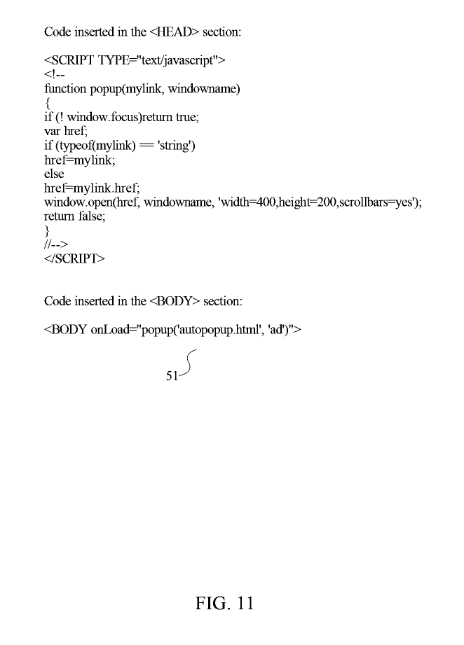

In reference to FIG. 11, a sample of code is provided that could be inserted into the webpage 41 HyperText Markup Language (HTML) in order to create an authentication pop-up 50. The authentication source code 51 can include script for the browser cookie 53. In this way, the attendee would not have to re-enter authentication credentials 52 each time the attendee returns to a webpage 41 on the network. Rather the authentication credentials 52 or the authorization for access could be stored for a predetermined amount of time until the user authentication credentials 52 are again requested. In the preferred embodiment of the present invention, the predetermined amount of time is equal to the duration of an event. For example, if the user signs up for a three day event, once authorized, his or her authentication credentials 52 would be stored for a seventy two hours time period during which the user will not be prompted to re-enter said authorization credentials to gain access to the controlled network. The authentication source code 51 should include script such that the authentication pop-up 50 remains open until user authorization to the webpage 41 has been provided. The authentication source code 51 should also include script such that authentication pop-up 50 remains open above the requested webpage 41 preventing user access to the webpage 41 until proper authentication credentials 52 have been entered and verified. The code provided is only to provide a basic example of the code that can be used. Any number of scripts or coding methods can be used to provide an authentication pop-up 50. Additionally, any number of other features pertaining to the function of the authentication pop-up 50 can be employed.

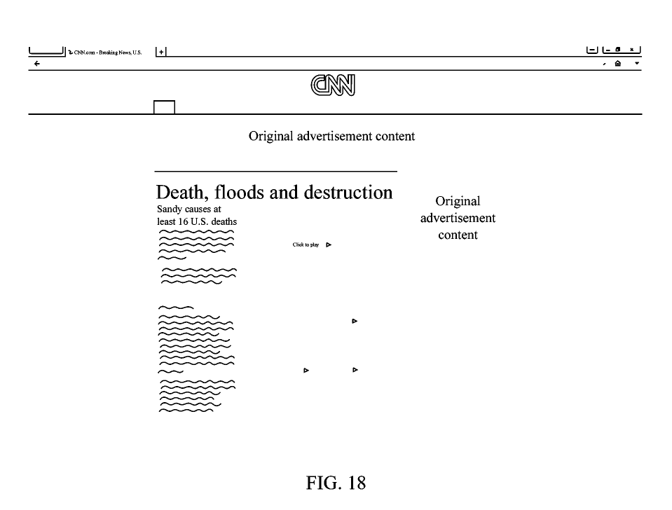

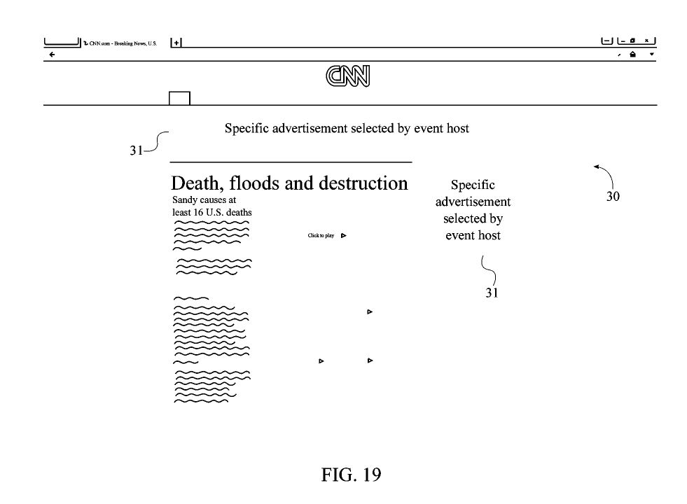

In reference to FIG. 1, once the user controlled device 13 for the specific account 11 has been successfully authenticated and granted access to the controlled network, the event based advertisements 30 can be distributed to the user controlled device 13 for the specific account 11. Advertisements for larger, nationwide corporations can be replaced with advertisements for local events and exhibits, as depicted by FIG. 18-19. In the preferred embodiment of the present invention, each of the event based advertisements 30 contains information relating to the event in progress, such as abstracts, times, locations, statuses, and other details of lectures, exhibits, presentations, luncheons, dinners, and award ceremonies. The event based advertisements 30 may be both location and time specific.

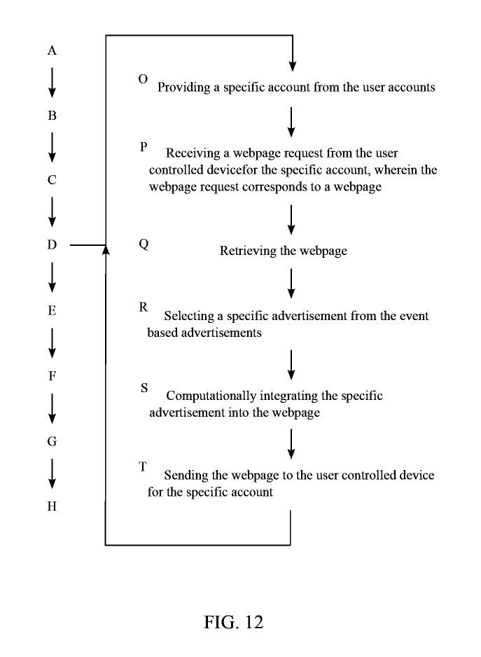

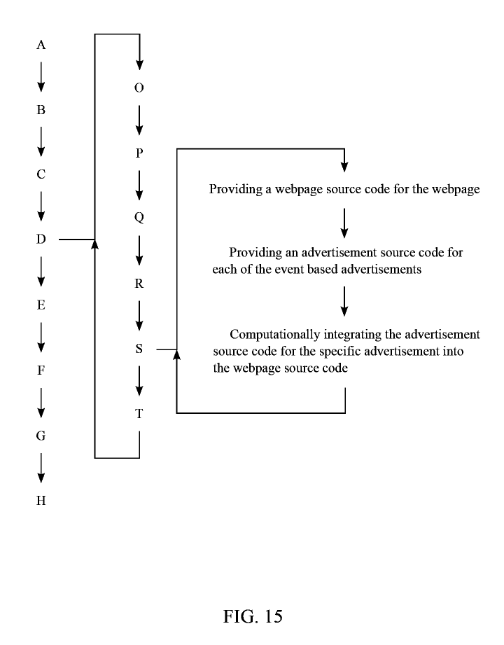

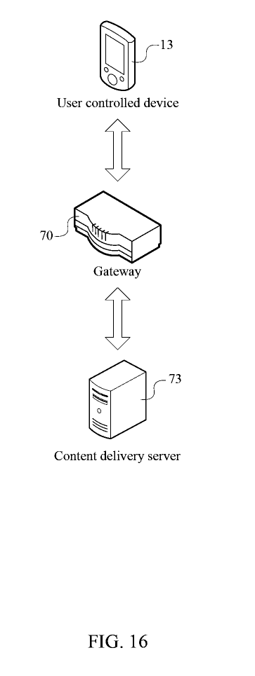

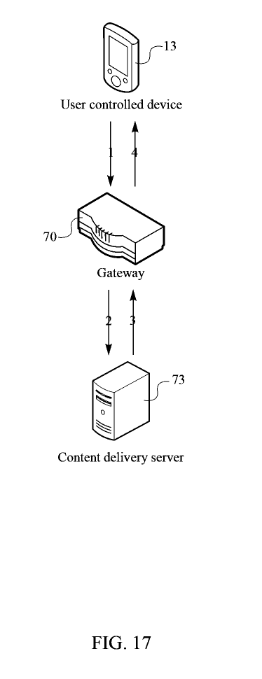

The at least one gateway 70 is connected to the content delivery system 73, as depicted in FIG. 16, wherein the content delivery system 73 provides the event based advertisements 30. In reference to FIG. 12 and FIG. 17, the at least on gateway receives a webpage request 40 from the user controlled device 13 for the specific account 11, wherein the webpage request 40 corresponds to a webpage 41. The webpage 41 is then retrieved through the controlled network, while a specific advertisement 31 is selected from the event based advertisements 30 by the content delivery system 73. In reference to FIG. 15, once the webpage 41 is retrieved and the specific advertisement 31 is selected, then an advertisement source code 32 for the specific advertisement 31 is computationally integrated into the webpage source code 42 for the webpage 41, wherein the specific advertisement 31 is computationally integrated into the webpage 41. The specific advertisement 31 can be integrated into the webpage 41 by the at least one gateway 70 or the content delivery system 73. Again in reference to FIG. 12 and FIG. 17, once the specific advertisement 31 is integrated into the webpage 41, the webpage 41 is sent to the user controlled device 13 for the specific account 11 by the at least one gateway 70.

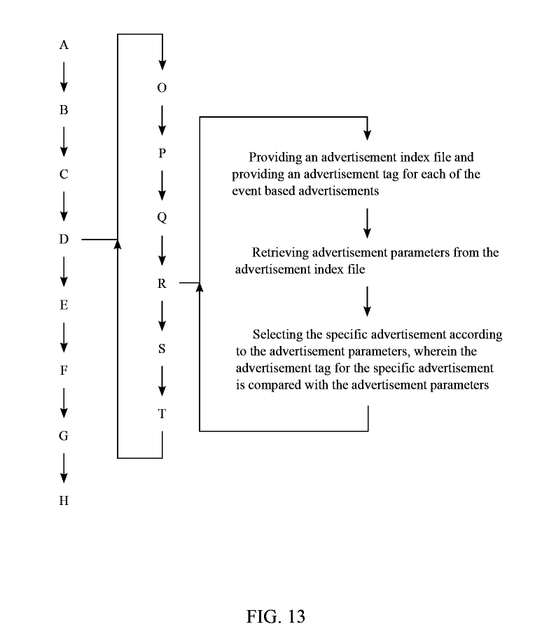

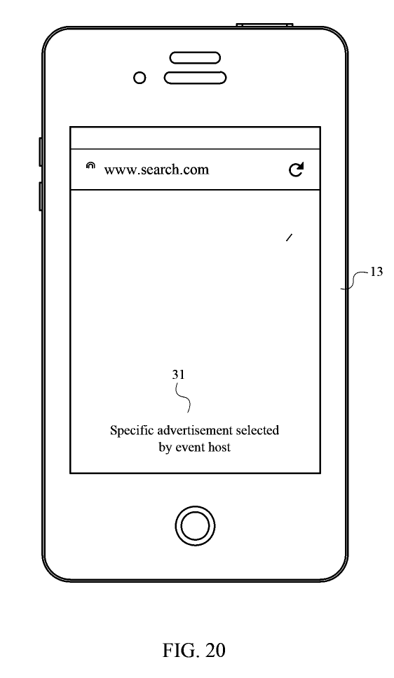

In reference to FIG. 13, an advertisement tag 33 is provided for each of the event based advertisements 30 by the content delivery system 73. The advertisement tag 33 contains information in regards to the type of file being sent to the gateway (i.e. image file, video file, flash file, etc.) and the content of the advertisement, and can also contain information to verify that the advertisement is for the correct event. The event name, address, phone number or other suitable information or a combination of such can be used to verify the correct event. The advertisement tag 33 for the specific advertisement 31 is compared to the advertisement parameters 61, and if verified, the specific advertisement 31 is then inserted into the webpage 41 and sent to the user controlled device 13 for the specific account 11 through the at least one gateway 70. The specific advertisement 31 is either inserted in place of, or overlaying the original advertisement, as depicted in FIG. 19-20. Additionally, the content delivery system 73 records the number of advertisements sent to the at least one gateway 70.

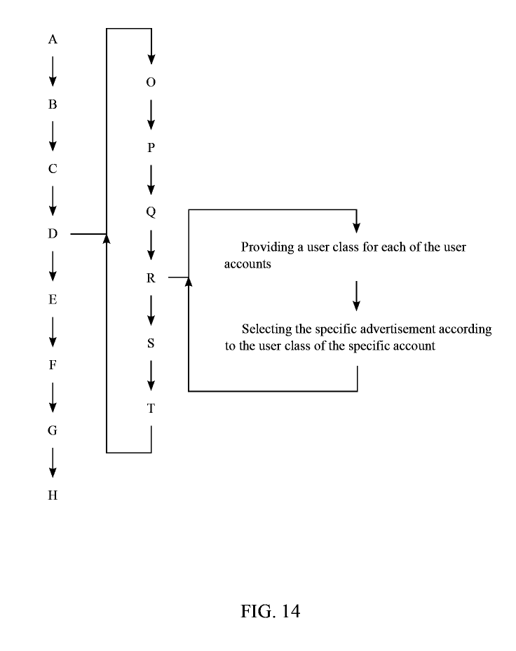

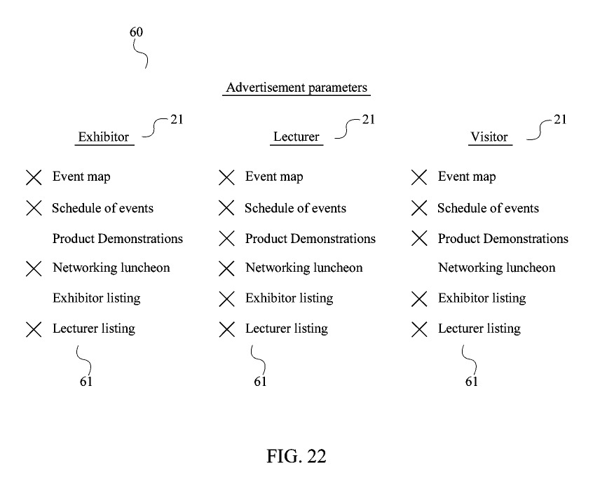

In further reference to FIG. 13, the specific advertisement 31 selected from the event based advertisement is defined by an advertisement index file 60 that is stored on the at least one gateway 70. The event host has control over the advertisement index file 60 and thus can determine the advertisement content that is distributed over the controlled network by adjusting advertisement parameters 61 stored in the advertisement index file 60. In the preferred embodiment of the present invention, each of the advertisement parameters 61 is established before the start of the event, wherein each of the advertisement parameters 61 is organized under the user class 21 of the attendees, as depicted in FIG. 22. In reference to FIG. 14, the user class 21 under which the advertisement parameters 61 fall, determines what kind of information is delivered to the attendees of the event. In this way, the specific advertisement 31 is selected according to the user class 21 of the specific account 11. For example, the attendees with the user class 21 designated as very important person (VIP) would be supplied with information on upcoming VIP only meetings or events, while the attendees with the user class 21 designated as regular visitor would receive a default schedule and information. This ensures explicit advertisement material on a higher degree of individuality.

Communications are established between the content delivery system 73 and the at least one gateway 70. If a predetermined interval of time has expired, then the content delivery system 73 will search for any updates to the advertisement parameters 61 in the advertisement index file 60 when communications are first established. The interval of time for which the content delivery system 73 searches for updates is defined in the advertisement index file 60. The content delivery system 73 is then updated according to the updates found within the advertisement index file 60. The content delivery system 73 then accesses the advertisement parameters 61 defined in the advertisement index file 60 in order to determine the appropriate types of advertisement content that can be delivered to each of the attendees.

The advertisement index file 60 allows the event host to determine the types of advertisements that are distributed over the controlled network. The event host can control the advertisement parameters 61 listed in the advertisement index file 60 through a central open-source software. The event based advertisements 30 can be blocked based on genre, content, location of the event, user class 21, etc. using the advertisement parameters 61. In this way, the event based advertisements 30 displayed on the user controlled device 13 for the user accounts 10 is determined by conference location as the at least one gateway 70 for a particular event contains an advertisement index file 60 with unique advertisement parameters 61.

The advertisement index file 60 also contains information regarding the location of both the at least one gateway 70. The physical location of the at least one gateway 70 is stored in the advertisement index file 60. This is used to verify that an advertisement is for a local event by matching location information stored in the advertisement tag 33 of each of the event based advertisements 30 with the location of the at least one gateway 70. The advertisement index file 60 also contains a list of allowed content delivery systems along with information regarding the location of the content delivery system 73. Location information such as Media Access Control (MAC) address, Fully Qualified Domain Name (FQDN), IP address, etc. is used such that the gateway can locate and communicate with the content delivery system 73.

Furthermore, the advertisement index file 60 contains information in regards to how information is handled. The bitrate limits for multimedia content such as mpeg2 or mpeg4 videos can be defined using the advertisement index file 60. In this way the quality of the files distributed by the gateway can be limited based on the capabilities of the gateway. The advertisement index file 60 can also provide content caching or storage of multimedia content. Multimedia content can also be stored remotely in addition to being locally stored. The advertisement index file 60 contains information regarding a web or file transfer protocol (FTP) server. This information is used to store and retrieve multimedia files that are being remotely stored due to their size. Large multimedia files take up too much space and are thus stored remotely.

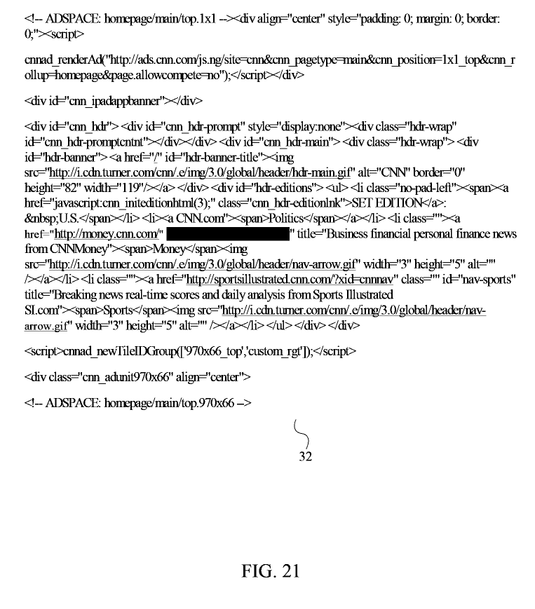

In reference to FIG. 21, in the preferred embodiment of the present invention, a HTML insert is used to insert the event based advertisements 30 into a webpage 41. The types of advertisements inserted are determined by the advertisement parameters 61 defined in the advertisement index file 60.

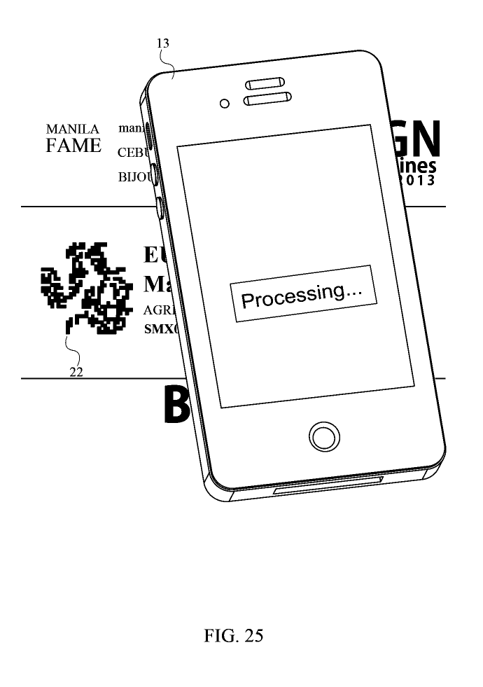

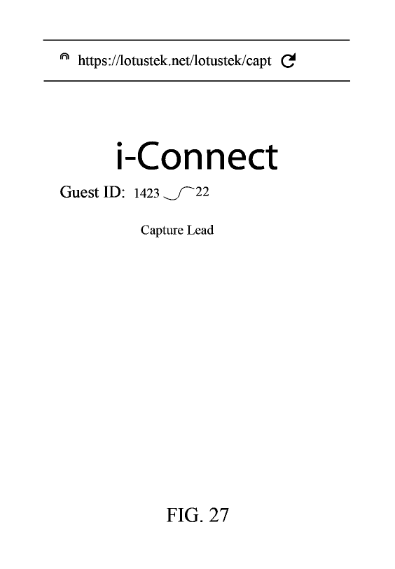

In reference to FIG. 1, once the user controlled device 13 for each of the user accounts 10 is authenticated, the attendees can then exchange data using the data storage medium 22 on the event badge of each of the attendees. In the preferred embodiment of the present invention, a host software application is operated on the user controlled device 13 for each of the user accounts 10. With the host software open and running on the user controlled device 13, the data storage medium 22 can then be recorded on the user controlled device 13 for each of the user accounts 10. If the user controlled device 13 has a scanning device, then the QR code on the badge of each of the attendees can be scanned, as depicted in FIG. 25. The registration data 20 for the scanned QR code is then either directly retrieved by the user controlled device 13 or retrieved from the host database 74 by referencing the QR code. If the user controlled device 13 does not have a scanning device, then the personal identification number on the badge of each of the attendees can be manually entered into the host software application in order to retrieve the registration data 20, as depicted in FIG. 27.

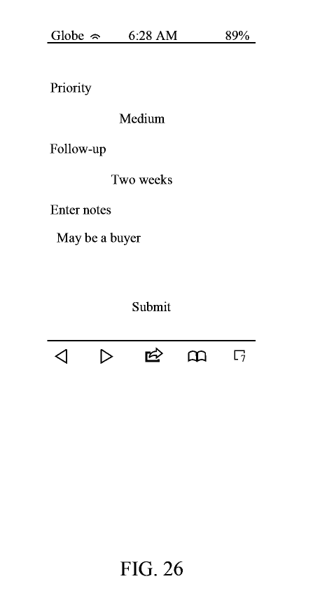

When the user controlled device 13 of a specific account 11 retrieves the registration data 20 of other accounts 12 from the user accounts 10, the user class 21 of each of the other accounts 12 acts to restrict information from the registration data 20 of the other accounts 12 depending on the user class 21 of the specific account 11. For example, if the user class 21 of the specific account 11 is designated as buyer and the user class 21 of the other accounts 12 is also designated as buyer, then the information such as the interests and the email addresses of each of the user accounts 10 may be withheld from each other for the benefit of both parties. The extent to which the information is restricted is dependent on predetermined privacy parameters as defined by the event host prior to the event. Additionally, when the registration data 20 is retrieved by the user controlled device 13, an attendee can enter additional information in regards to the other user accounts 10 through the host software application, as depicted in FIG. 26. The additional information may include a contact priority rating, a follow up date, or additional notes.

In reference to FIG. 1, the controlled network receives scan data 23 from the user controlled device 13 for each of the user accounts 10 throughout the event and stores the scan data 23 in the host database 74. The scan data 23 is in relation to the data storage medium 22 of each of the user accounts 10, and can include information such as the registration data 20 associated with the data storage medium 22 and the number of times the data storage medium 22 was recorded by the user accounts 10. The additional information entered by the attendees is also stored in the scan data 23.

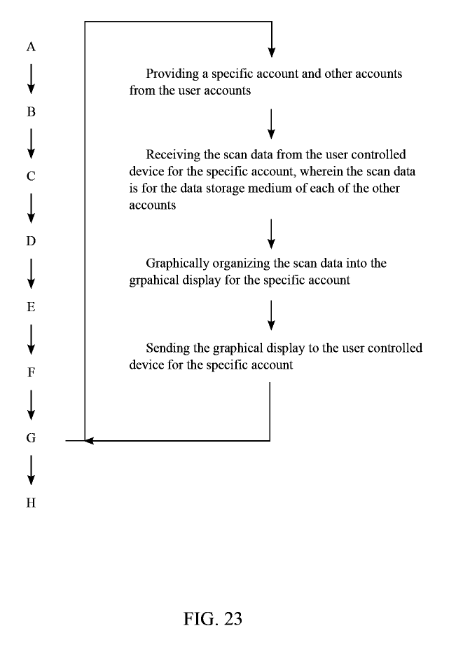

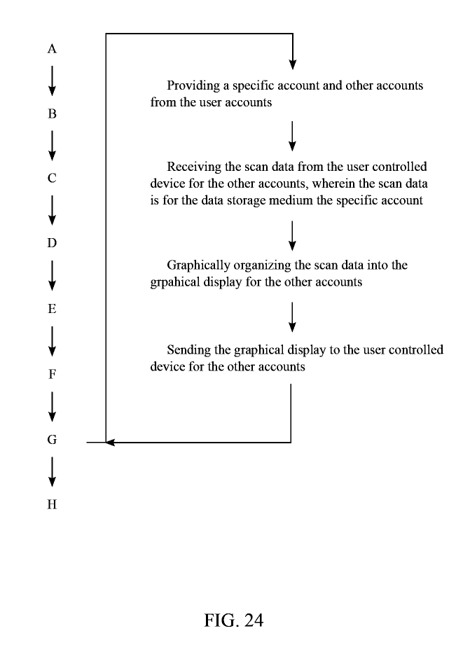

The scan data 23 is recorded in two ways in particular. In reference to FIG. 23, the controlled network receives the scan data 23 from the user controlled device 13 for the specific account 11, wherein the scan data 23 is for the data storage medium 22 of the each of the other accounts 12. For example, when an attendee scans the QR code of the other attendees, the registration data 20 for the other attendees is then stored under the specific account 11 of the attendee. In reference to FIG. 24, at the same time, the controlled network receives the scan data 23 from the user controlled device 13 for the other accounts 12, wherein the scan data 23 is for the data storage medium 22 of the specific account 11. For example, when the QR code of an attendee is scanned by the other attendees, the registration data 20 for the attendee is stored under the other accounts 12 of the other attendees. Certain information such as the number of times the data storage medium 22 was recorded by the user accounts 10, the user class 21 of the data storage medium 22 being recorded, the user class 21 of the specific account 11 that is recording the data storage medium 22 of the other accounts 12, and the time at which the data storage medium 22 for each of the user accounts 10 is recorded are stored in the host database 74 and displayed to the event host in real time.

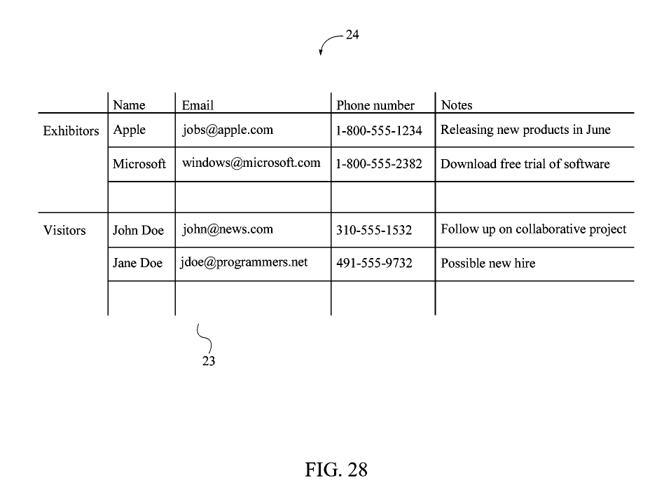

In reference to FIG. 1, when the event is over, the scan data 23 is graphically organized into a graphical display 24 for each of the user accounts 10. The scan data 23 for the data storage medium 22 of the other accounts 12 is graphically organized into the graphical display 24 for the specific account 11, as depicted in FIG. 23, while the scan data 23 for the data storage medium 22 of the specific account 11 is graphically organized into the graphical display 24 for the other accounts 12, as depicted in FIG. 24. The graphical display 24 is then sent to the user controlled device 13 for each of the user accounts 10 through the host software application or via email. The graphical display 24 for the scan data 23 of the other accounts 12 is sent to the user controlled device 13 for the specific account 11, as depicted in FIG. 23, while the graphical display 24 for the scan data 23 of the specific account 11 is sent to the user controlled device 13 for the other accounts 12, as depicted in FIG. 24. The graphical display 24 can be formatted in any number of ways, such as a list, chart, spreadsheet, etc. In reference to FIG. 28, the graphical display 24 provides information in regards to the data storage medium 22 of each of the other accounts 12 that were recorded by the specific user account.

Although the invention has been explained in relation to its preferred embodiment, it is to be understood that many other possible modifications and variations can be made without departing from the spirit and scope of the invention as hereinafter claimed.

What is claimed is:

1. A method for exchanging data in a controlled network includes the steps of:
providing a plurality of user accounts and a user controlled device for each of the user accounts;
receiving registration data for each of the user accounts;
generating a data storage medium for each of the user accounts, wherein the registration data is embedded in the data storage medium for each of the user accounts;
authenticating the user controlled device for each of the user accounts;
sending a plurality of event based advertisements to the user controlled device for each of the user accounts;
receiving scan data from the user controlled device for each of the user accounts, wherein the scan data is for the data storage medium of each of the user accounts;
graphically organizing the scan data into a graphical display for each of the user accounts; and
sending the graphical display to the user controlled device for each of the user accounts.

2. The method for exchanging data in a controlled network as claimed in claim 1 further includes the steps of:
providing a specific account and other accounts from the user accounts;
receiving the scan data from the user controlled device for the specific account, wherein the scan data is for the data storage medium of each of the other accounts;
graphically organizing the scan data into the graphical display for the specific account; and
sending the graphical display to the user controlled device for the specific account.

3. The method for exchanging data in a controlled network as claimed in claim 1 further includes the steps of:
providing a specific account and other accounts from the user accounts;
receiving the scan data from the user controlled device for the other accounts, wherein the scan data is for the data storage medium of the specific account;
graphically organizing the scan data into the graphical display for the other accounts; and
sending the graphical display to the user controlled device for the other accounts.

4. The method for exchanging data in a controlled network as claimed in claim 1 further includes the steps of:
retrieving a user class from the registration data for each of the user accounts; and
embedding the user class in the data storage medium for each of the user accounts, wherein the user class restricts access to information embedded in the data storage medium for each of the user accounts.

5. The method for exchanging data in a controlled network as claimed in claim 1 further includes the steps of:
providing a specific account from the user accounts;
receiving a webpage request from the user controlled device for the specific account, wherein the webpage request corresponds to a webpage;
retrieving the webpage and computationally integrating an authentication pop-up into the webpage;
sending the webpage to the user controlled device for the specific account;
receiving authentication credentials for the specific account from the user controlled device for the specific account; and
verifying the authentication credentials for the specific account.

6. The method for exchanging data in a controlled network as claimed in claim 5 further includes the steps of:
providing a webpage source code for the webpage;
providing an authentication source code for the authentication pop-up; and
computationally integrating the authentication source code into the webpage source code.

7. The method for exchanging data in a controlled network as claimed in claim 5 further includes the steps of:
removing the authentication pop-up from the webpage,
if the authentication credentials for the specific account is verified;
storing the authentication credentials in a browser cookie; and
sending the browser cookie to the user controlled device for the specific user account.

8. The method for exchanging data in a controlled network as claimed in claim 7 further includes the steps of:
setting an expiration time for the browser cookie.

9. The method for exchanging data in a controlled network as claimed in claim 1 further includes the steps of:
providing a specific account from the user accounts;
receiving a webpage request from the user controlled device for the specific account, wherein the webpage request corresponds to a webpage;
retrieving the webpage;
selecting a specific advertisement from the event based advertisements;
computationally integrating the specific advertisement into the webpage; and
sending the webpage to the user controlled device for the specific account.

10. The method for exchanging data in a controlled network as claimed in claim 9 further includes the steps of:
providing an advertisement index file;
retrieving advertisement parameters from the advertisement index file; and
selecting the specific advertisement according to the advertisement parameters.

11. The method for exchanging data in a controlled network as claimed in claim 10 further includes the steps of:
providing an advertisement tag for each of the event based advertisements; and
comparing the advertisement tag for the specific advertisement with the advertisement parameters.

12. The method for exchanging data in a controlled network as claimed in claim 9 further includes the steps of:
providing a user class for each of the user accounts; and
selecting the specific advertisement according to the user class of the specific account.

13. The method for exchanging data in a controlled network as claimed in claim 9 further includes the steps of:
providing a webpage source code for the webpage;
providing an advertisement source code for each of the event based advertisements; and
computationally integrating the advertisement source code for the specific advertisement into the webpage source code.

14. A method for exchanging data in a controlled network includes the steps of:
providing a plurality of user accounts and a user controlled device for each of the user accounts, wherein the user accounts includes a specific account and other accounts;
receiving registration data for each of the user accounts;
generating a data storage medium for each of the user accounts, wherein the registration data is embedded in the data storage medium for each of the user accounts;
authenticating the user controlled device for each of the user accounts;
sending a plurality of event based advertisements to the user controlled device for each of the user accounts;
receiving the scan data from the user controlled device for the specific account, wherein the scan data is for the data storage medium of each of the other accounts;
graphically organizing the scan data into the graphical display for the specific account;
sending the graphical display to the user controlled device for the specific account;
receiving the scan data from the user controlled device for the other accounts, wherein the scan data is for the data storage medium of the specific account;
graphically organizing the scan data into the graphical display for the other accounts; and
sending the graphical display to the user controlled device for the other accounts.

15. The method for exchanging data in a controlled network as claimed in claim 14 further includes the steps of:
retrieving a user class from the registration data for each of the user accounts; and
embedding the user class in the data storage medium for each of the user accounts, wherein the user class restricts access to information embedded in the data storage medium for each of the user accounts.

16. The method for exchanging data in a controlled network as claimed in claim 14 further includes the steps of:
providing an authentication source code for the authentication pop-up;
receiving a webpage request from the user controlled device for the specific account, wherein the webpage request corresponds to a webpage;
retrieving the webpage, wherein the webpage includes webpage source code;
computationally integrating the authentication source code into the webpage source code, wherein an authentication pop-up is integrated into the webpage;
sending the webpage to the user controlled device for the specific account;
receiving authentication credentials for the specific account from the user controlled device for the specific account; and
verifying the authentication credentials for the specific account.

17. The method for exchanging data in a controlled network as claimed in claim 16 further includes the steps of:
removing the authentication pop-up from the webpage,
if the authentication credentials for the specific account is verified;
storing the authentication credentials in a browser cookie;
setting an expiration time for the browser cookie; and
sending the browser cookie to the user controlled device for the specific user account.

18. The method for exchanging data in a controlled network as claimed in claim 14 further includes the steps of:
providing an advertisement source code for each of the event based advertisements;
providing an advertisement index file;
receiving a webpage request from the user controlled device for the specific account, wherein the webpage request corresponds to a webpage;
retrieving the webpage, wherein the webpage includes webpage source code;
retrieving advertisement parameters from the advertisement index file;
selecting a specific advertisement from the event based advertisements, wherein the specific advertisement is selected according to the advertisement parameters;
computationally integrating the advertisement source code for the specific advertisement into the webpage source code, wherein the specific advertisement is integrated into the webpage; and
sending the webpage to the user controlled device for the specific account.

19. The method for exchanging data in a controlled network as claimed in claim 18 further includes the steps of:
providing an advertisement tag for each of the event based advertisements; and
comparing the advertisement tag for the specific advertisement with the advertisement parameters.

20. The method for exchanging data in a controlled network as claimed in claim 18 further includes the steps of:
providing a user class for each of the user accounts; and
selecting the specific advertisement according to the user class of the specific account.
